(19) United States
(12) Patent Application Publication
(10) Pub. No.: US 2012/0304603 A1
(43) Pub. Date: Dec. 6, 2012

(54) LOW ELONGATION STRUCTURES FOR HOT GAS FILTRATION

(75) Inventors: KURT HANS WYSS, CHAVANNES DE BOGIS (CH); YANNICK ALBERTONE, GEX (FR)

(73) Assignee: E. I. DU PONT DE NEMOURS AND COMPANY, Wilmington, DE (US)

(21) Appl. No.: 13/313,428

(22) Filed: Dec. 7, 2011

Related U.S. Application Data
(60) Provisional application No. 61/420,990, filed on Dec. 8, 2010.

(51) Int. Cl. B01D 39/14; B32B 37/00; B01D 46/02

(52) U.S. Cl. 55/382; 55/486; 156/60

(57) ABSTRACT

Structures containing a fiber mat inserted into a high modulus scrim of minimum basis weight 35 gsm. The structures have reduced tensile elongation at 50 N per 5 cm fabric strip in MD under ISO 9073-3 standard norm. The structure has a basis weight of at least 9 ounces per square yard (305 grams per square meter). The structure also has heat resistance of at least 150° to 190° C., preferably over 200 up to 260° C. to for service under typical hot flue gas filtration conditions. Filter bags made from these structures provide a controlled dimensional stability over their entire filter life time. In addition such stable structures are suitable for lamination with fragile membranes especially e-PTFE membranes where minimum amount of mechanical damage to the membrane occurs.

### BACKGROUND OF THE INVENTION

The use of fabric filters has grown significantly as environmental standards for particulate emissions have become more stringent. Fabric filters are used because they are highly efficient, easily operated and in many cases the least expensive method of control of such emissions. Filter bag fabric is of extreme importance since one fabric may function much better than another fabric in the same environment. During the filtration process, the filtering media stops and collect particles on its surface or in depth. All along its work life, and according to filtering equipment design, media sustains its own weight combined with collected particles mass. This leads to mechanical stress and subsequent media dimensional change such as elongation. New filter fabric constructions of improved filtering capacity over its entire service life is a desirable goal. The present invention is for a filter fabric and a filter with low elongation, capable of maintaining an improved dimensional stability throughout its filter service life.

### SUMMARY OF THE INVENTION

The present invention provides a fabric laminate structure with minimum elongation properties at the beginning of the elongation force cycle needed to maintain filter media dimension stability during the dust loading and cleaning cycle in hot gas filtration. The fabric comprises a fiber mat of high temperature resistant fibers. This mat is entangled such as hydroentangled or needlepunched to a support scrim wherein the support scrim has a basis weight of at least 35 grams per square meter and the support scrim is located interior to the fiber mat such that the fibers of the mat are intermingled with the support scrim.

The fibers of the fiber mat may include materials such as, but not limited to aramid, poly amid-imide, polyarylene sulfide, polyimide, polysulfone fibers. The fabric laminate structure has a basis weight of at least 9 ounces per square yard (305 grams per square meter—gsm.) The support scrim may comprise low elongation organic fibers such as, but not limited to p-aramid; or inorganic fibers such as, but not limited to glass, metallic, etc. fibers. Preferably the support scrim is a woven, or it is a “laid down” structure if the scrim comprises glass fiber.

The machine direction (MD) elongation of the support scrim and the fabric laminate is measured at 50 Newtons (N) force over a 5 cm wide fabric strip according to ISO 9073-3. The fabric laminate may be made by needlepunching, spunlacing (or hydroentangling) the fiber mat and the support scrim together. In addition such low elongation spunlaced fabrics are capable of being laminated to a fragile membrane and offer a minimum amount of mechanical damage to the membrane during end use.

The invention is also directed to a fabric structure having a basis weight of at least 305 grams per square meter (gsm) comprising a fiber mat, wherein the fabric structure has an elongation of less than 3.0% extension in the machine direction under a load of 50 Newtons over a 5 cm wide strip under standard test ISO 9073-3 and wherein the fabric structure has heat resistance after 2 years of aging at 150° C. defined as at least 30% retention of initial tensile strength. The fiber mat is entangled preferably hydroentangled to a support scrim wherein the scrim has a basis weight of at least 35 grams per square meter and the scrim is located interior to the fiber mat.

The present invention is also directed to a filter assembly comprising the fabric and a method for making the fabric laminate structure.

The invention is also directed to a method of forming a fabric laminate structure comprising the steps of;
i. providing a mat of loose fibers in a form suitable for entangling,
ii. inserting a support scrim into the mat of loose fibers, or adjacent to and in contact with the batt of loose fibers,
iii. entangling preferably by hydroentangling or needlepunching the loose fibers and the support scrim to form a structure in which the loose fibers become intermingled with the support scrim.

The loose fibers comprise any of the materials described herein that the nonwoven mat comprises. The support scrim comprises any of the materials described herein that the support scrim of the product of the invention comprises. The intermingled structure may have any of the physical or thermal properties that the fabric laminate structure of the product of the invention may have.

### BRIEF DESCRIPTION OF THE FIGURE

FIG. 1 shows an embodiment of a filter bag of the invention.

### DETAILED DESCRIPTION OF THE INVENTION

### Definitions

Applicants specifically incorporate the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

The term “nonwoven” means a web including a multitude of randomly distributed fibers. The fibers generally can be bonded to each other or can be unbonded. The fibers can be staple fibers or continuous fibers. The fibers can comprise a single material or a multitude of materials, either as a combination of different fibers or as a combination of similar fibers each comprised of different materials. The term “mat” may refer herein to a collection of loose or carded fibers. The term “mat” may also refer to a nonwoven, where the limitation of the meaning is only that the final claimed structure be obtained therefrom.

The terms “spunlaced”, “hydro entangled”, and “hydro laced” are synonymous herein. As used herein, the term “spunlaced” when applied to a mat, fabric or web refers to a web of material consisting of one or more types of preferably non-continuous fibers, where the fibers are hydroentangled to achieve mechanical bonding without binder materials or thermal bonding. As used herein, the term “hydroentangle” or “hydroentangling” or “hydro lacing” refers to a process wherein a web of material consisting of one or more types of fibers or filaments are subjected to high-velocity water jets, which entangle the fibers to achieve mechanical bonding. The spunlaced processes disclosed in U.S. Pat. Nos. 3,508,308 and 3,797,074 are examples of methods known in the art that are useful in the manufacture of nonwoven fabrics and felt.

“Entangling” is understood to mean both hydroentangling and needlepunching.

### Description of the Preferred Embodiments

The present invention provides a fabric laminate with minimum elongation properties at the beginning of the elongation force cycle needed to maintain filter media dimensional stability during dust loading and cleaning cycle in hot gas filtration. The fabric laminate comprises a nonwoven mat or nonwoven structure of high temperature resistant fibers such as, but not limited to aramid, poly amid-imide, polyarylene sulfide, polyimide, polysulfone fibers, said mat having a basis weight of at least 9 ounces per square yard (305 grams per square meter—gsm.) and a support scrim. The support scrim may be a woven or laid down fabric comprising low elongation fibers such as, but not limited to p-aramid; glass or metallic fibers. Support scrim elongation should be below 3% or preferably below 1% or even 0.1% when the MD elongation is measured at 50 N force across a 5 cm wide scrim strip according to ISO 9073-3. The scrim has a basis weight of at least 35 grams per square meter and the scrim is located interior to the fiber mat or nonwoven.

The final fabric laminate elongation should be below 3% or preferably 1% or even 0.1% where the MD elongation is measured at 50 N force per a 5 cm wide scrim strip according to ISO 9073-3. The fabric laminate may be made by spunlacing or hydro entangling one or more nonwoven mats and the support scrim together. The mat may comprise loose fibers before hydroentangling. After entangling, the fibers of the mat or nonwoven will penetrate the scrim and the total structure may condense and densify. As used herein, the term “the scrim is located interior to the fiber mat” means that the fibers of the mat and the support scrim are intermingled, and that the overall structure may be densified relative to the original starting materials before hydroentangling.

In addition such low elongation fabric laminates are capable of being laminated to a fragile membrane, for example expanded polytetrafluoroethylene (e-PTFE), offering a minimum amount of mechanical damage to the membrane. In one embodiment the invention is directed to a fabric laminate structure as disclosed above, laminated to an e-PTFE membrane. There may also be a layer of adhesive between the e-PTFE membrane and the fabric laminate, and this adhesive may be, in one embodiment, a fluorinated ethylene propylene resin (tetrafluoroethylene/hexafluoropropene copolymer.

The present invention is also directed to a filter assembly comprising the fabric.

In dust-cake or surface filtration applications, the present inventors discovered that filtration fabrics and filters incorporating the present invention gave a constant high filtration performance in respect of dust retention and low pressure drop over its' entire service. The purpose of the present invention is to provide a fabric with low elongation at the necessary stress exerted during dust cake formation resulting in an additional weight on surface and compressed air cleaning cycles. It is anticipated that lower and more uniform elongation of the filter bag will lead to more uniform cake loading and air flow, resulting in lower pressure drop across the filter. By controlling the low elongation performance over its entire filtration service life, such structures are suitable for the use in very long filters and the common use of functional membranes such as, but not limited to, e-PTFE membranes for either improving dust cake release properties, time between the periodic cleaning cycles (i.e. economical reasons), or improving dust particle penetration through the filter. Such a low elongation filter material allows application of reasonable stretch to the relatively fragile functional membrane such as an e-PTFE membrane without damaging it mechanically and reduces the risk of delaminating during the service life. In case of a possible premature failure of the membrane, the spunlaced structures used will still ensure a sufficiently high level filtration performance until the end of the filter's service life.

In a preferred embodiment the fabric laminate is formed by hydro entangling of the fiber mat and the support scrim. To produce a hydro entangled, spunlaced structure for technical application such as hot gas filtration application, it is necessary to obtain a basis weight of at least 305 g/m². The conventional hydro entangled machine can typically yield fabric of less than 135 g/m². In recent years, water jet intermingled equipments were further advanced so that heavier filtration media basis weight can be achieved on such machines.

The fabric laminate may also be formed by needlepunching of the nonwoven mat and the scrim support together. Needlepunching is achieved with barbed felting needles repeatedly passing into and out of the web. Needle punching processes disclosed in U.S. Pat. No. 2,910,763 and U.S. Pat. No. 3,684,284 are examples of conventional methods well known in the art that are useful in the manufacture of the nonwoven fabrics and felt.

The preparation of the bulky fiber mats needed as a precursor to the final structure can be the same for both techniques (needlepunching and/or spunlacing). For example, in one embodiment, clumps of crimped staple fibers obtained from bales of fiber can be opened by a device such as a picker and then blended by any available method, such as air conveying. The fibers can then be converted into a nonwoven fabric or felt using conventional methods as mentioned previously. Generally this involves forming a fibrous web by use of a device such as a card, although other methods, such as or wet-laying of the fibers may be used. Instead of a cross lapper a fiber air-lay system can be used as well, where the single web is prepared to the desired weight and isotropic fiber direction of the final bat prior to densification. Therefore the key difference between needle punching and spunlacing is the densification step. Where as in needle felting, the densification is made by using barbed metal needles, during spun-lacing the densification of the fiber web with a water curtain produced with thousands of high pressurized tiny water jets.

The support scrim, useful in this invention may be inorganic. In particular the support scrim may include a “laid down” structure of filament glass fibers such as made by Kirson GMBH(Donau, Germany.) This laid scrim looks like a grid or lattice. It is made from continuous glass filament into a rectangular scrim. In order to keep the yarns in the desired right-angled position it is necessary to join these yarns together. In contrast to woven products the fixation of the warp and weft yarns in laid scrims are done by chemical bonding which during the spunlacing process is eliminated by the water jets.

The support scrim may also be a woven structure and may comprise metal fibers. The support scrim may also comprise or consist of para-aramid (p-aramid) fibers.

The meta-aramid fiber useful in this invention in the nonwoven mat includes meta-oriented synthetic aromatic polyamides. The polymers must be of fiber-forming molecular weight in order to be shaped into fibers. The polymers can include polyamide homo-polymers, copolymers, and mixtures thereof which are predominantly aromatic, wherein at least 85% of the amide (—CONH—) linkages are attached directly to two aromatic rings. The rings can be un-substituted or substituted. The polymers are meta-aramid when the two rings or radicals are meta oriented with respect to each other along the molecular chain. Preferably copolymers have no more than 10 percent of other diamines substituted for a primary diamine used in forming the polymer or no more than 10 percent of other diacid chlorides substituted for a primary diacid chloride used in forming the polymer. Additives can be used with the aramid; and it has been found that up to as much as 13 percent by weight of other polymeric material can be blended or bonded with the aramid. The preferred meta-aramids are poly(meta-phenylene isophthalamide)(MPD-I) and its copolymers. One such meta-aramid fiber is Nomex®. aramid fiber available from E. I. du Pont de Nemours and Company of Wilmington, Del., however, meta-aramid fibers are available in various styles under the trademarks Tejinconex®, available from Teijin Ltd. of Tokyo, Japan; New Star® Meta-aramid, available from Yantai Spandex Co. Ltd, of Shandong Province, China; and Chinfunex® Aramid 1313 available from Guangdong Charming Chemical Co. Ltd., of Xinhui in Guangdong, China. Meta-aramid fibers are inherently flame resistant and can be spun by dry or wet spinning using any number of processes; however, U.S. Pat. Nos. 3,063,966; 3,227,793; 3,287,324; 3,414,645; and 5,667,743 are illustrative of useful methods for making aramid fibers that could be used in this invention.

The para-aramid fiber useful in this invention includes aramid polymer, that is, a long-chain synthetic polyamide in which 85% or more of the amide linkages are attached directed to two aromatic rings. These aramids are well-known and readily available commercially from, for example, DuPont, of Wilmington, Del., which markets one such product under the trademark KEVLAR®. Another aramid is available under the trademark TWARON®, from the Twaron BV division of the Teijin Group.

Blends of meta-aramid fiber and para-aramid fiber can also be used in this invention for the nonwoven mat.

The nonwoven mat may also comprise a polyarylene sulfide. The polyarylene sulfides (PAS) useful in the invention include linear, branched or cross linked polymers that include arylene sulfide units. Polyarylene sulfide polymers and their synthesis are known in the art and such polymers are commercially available.

Exemplary polyarylene sulfides useful in the invention include polyarylene thioethers containing repeat units of the formula —[(Ar¹)ₙ—X]ₘ—[(Ar²)ᵢ—Y]ⱼ—(Ar³)ₖ—Z]ₗ—[(Ar⁴)ₒ—W]ₚ— wherein Ar¹, Ar², Ar³, and Ar⁴ are the same or different and are arylene units of 6 to 18 carbon atoms; W, X, Y, and Z are the same or different and are bivalent linking groups selected from —SO₂—, —S—, —SO—, —CO—, —O—, —COO— or alkylene or alkylidene groups of 1 to 6 carbon atoms and wherein at least one of the linking groups is —S—; and n, m, i, j, k, l, o, and p are independently zero or 1, 2, 3, or 4, subject to the proviso that their sum total is not less than 2. The arylene units Ar¹, Ar², Ar³, and Ar⁴ may be selectively substituted or unsubstituted. Advantageous arylene systems are phenylene, biphenylene, naphthylene, anthracene and phenanthrene. The polyarylene sulfide typically includes at least 30 mol %, particularly at least 50 mol % and more particularly at least 70 mol % arylene sulfide (—S—) units. Preferably the polyarylene sulfide polymer includes at least 85 mol % sulfide linkages attached directly to two aromatic rings. Advantageously the polyarylene sulfide polymer is polyphenylene sulfide (PPS), defined herein as containing the phenylene sulfide structure —(C₆H₄—S)ₙ— (wherein n is an integer of 1 or more) as a component thereof.

A polyarylene sulfide polymer having one type of arylene group as a main component can be preferably used. However, in view of processability and heat resistance, a copolymer containing two or more types of arylene groups can also be used. A polyphenylene sulfide (PPS) resin comprising, as a main constituent, a p-phenylene sulfide recurring unit is particularly preferred since it has excellent processability and is industrially easily obtained. In addition, a polyarylene ketone sulfide, polyarylene ketone ketone sulfide, polyarylene sulfide sulfone, and the like can also be used.

Specific examples of possible copolymers include a random or block copolymer having a p-phenylene sulfide recurring unit and an m-phenylene sulfide recurring unit, a random or block copolymer having a phenylene sulfide recurring unit and an arylene ketone sulfide recurring unit, a random or block copolymer having a phenylene sulfide recurring unit and an arylene ketone ketone sulfide recurring unit, and a random or block copolymer having a phenylene sulfide recurring unit and an arylene sulfone sulfide recurring unit.

The polyarylene sulfides may optionally include other components not adversely affecting the desired properties thereof. Exemplary materials that could be used as additional components would include, without limitation, antimicrobials, pigments, antioxidants, surfactants, waxes, flow promoters, particulates, and other materials added to enhance processability of the polymer. These and other additives can be used in conventional amounts.

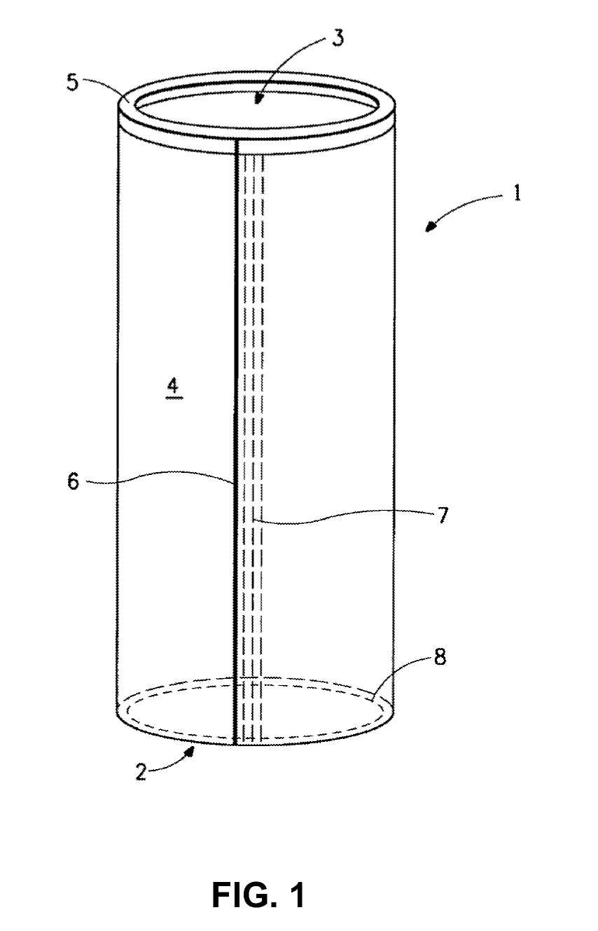

FIG. 1 illustrates one embodiment of the filter bag of this invention. Filter bag 1 has a closed end 2, an open end 3, and a tubular section 4. In the embodiment represented, the filter bag also has a spring steel metal snap ring 5 attached to the open end of the bag. The tubular section 4 of this bag is comprised of a filtration fabric laminate structure that is overlapped, forming a seam 6 sewn with triple stitching 7. The closed end of the bag in this embodiment is also comprised of a laminate structure that is stitched at 8 to the end of the bag used for the tubular section. While the figure represents a preferred embodiment, other potential constructions, orientations, and features of bag filters may be used, such as those disclosed in U.S. Pat. No. 3,524,304 to Wittemeier et al.; U.S. Pat. No. 4,056,374 to Hixenbaugh; U.S. Pat. No. 4,310,336 to Peterson; U.S. Pat. No. 4,481,022 to Reier; U.S. Pat. No. 4,490,253 to Tafara; and/or U.S. Pat. No. 4,585,833 to Tafara.

In some embodiments the closed end 2 of the filter bag, as shown in the FIG. 1, is a disk of filter material sewn to the tubular section. In some other embodiments the closed end can be made of some other material, for example in some situations a metallic closed end might be needed. In other embodiments the closed end can be ultrasonically, adhesively, or heat seamed or sealed in some other manner than sewing. In another embodiment the felt used in the tubular section of the bag can be gathered together or folded, and then sealed, to form the closed end.

In some embodiments the open end 3 of the bag may be provided with hardware to attach the bag to the cell plate. In some other embodiments the open end of the bag may be sized such that a snug fit is accomplished by sliding the bag over a specially designed cell plate.

In some embodiments of this invention the filtration material used in the tubular section 4 and optionally in the closed end 2 is a fabric laminate structure of the present invention.

In some embodiments the tubular section 4 and optionally in the closed end 2 of the filter bag of this invention is a single layer of filtration material. In some other embodiments, the tubular section is made of a filtration material supported by a scrim or reinforcing cloth that provides stability during pulsing of the bag. In a preferred embodiment shown in FIG. 1, the filtration material is overlapped to form a cylinder of filter material having a seam 6 that is then stitched with a high temperature thread, such as a thread having 3 to 6 strand plies of meta-aramid fiber, fluoro-polymer fiber, glass fiber, or combinations or blends thereof. In other embodiments, the overlapped seam can be sealed by ultrasonics, adhesives, heat, or some combination of all these seaming methods.

### Test Methods

### Tensile strength

The tensile strength of filtration material was measured according to “ISO 9073-3: “Standard Test Methods. For each sample, three (3) tests were conducted and the results were averaged and reported.

### Filtration Performance Test—VDI Test Method

For clean and unused filtration media, the filtration performance was tested according to VDI 3926 Part 1 “Standard Test for the Evaluation of Cleanable Filter Media,” published in October 2004. Briefly, a fabric sample of 15 cm in diameter was placed in the sample holder and underwent the specified filtration, cleaning, and aging cycles. After the aging cycles, key performance parameters such as dust leakage, average pressure drop, and pulsing cycle time were measured and reported for the last five (5) cycles of the performance testing phase.

To determine the performance of used filtration media retrieved from the bag house after a certain period of field use, a “Special VDI Test” was developed using the same test apparatus as in the VDI 3926 Test Method. A fabric sample of 15 cm in diameter was cut out from the used filter bag and placed in the sample holder. The “field-aged” fabric sample then underwent 30 normal filtration cycles on the laboratory test apparatus. Key performance parameters such as dust leakage, pressure drop, and pulsing cycle time were measured and reported for the last five (5) cycles. This test provides useful data on how the fabric would perform in the field by simulating the field use conditions in the laboratory.

### EXAMPLES

A) PPS Spunlaced Structures without-, with Metal-, Glass- and PPS Scrims

### Comparative Example A

### Spunlaced Filtration Structure of PPS Fiber without Scrim

Spunlaced fabric of PPS fibers was prepared by processing 250 kg of PPS fiber from Toray Japan in a conventional opener, feeding system and then air-transported to the bottom and top cards. The card webs were compiled to the desired weights prior to entering the hydro lacing equipment. The hydro lacing equipment was equipped with 7 water jet heads, having a pressure range of up to 200 bar each. The hydro lacing process was conducted at a speed of around 5 meters per minute and the fabric made had a basis weight of 523 grams per square meter.

### Example 1

### Spunlaced Filtration Structure of PPS Fibers with Metal Mesh Scrim

A spunlaced filtration structure was made following a procedure similar to that described in Example 1 except that prior tohydro lacing a 420 gsm heavy metal mesh scrim was inserted. The filter structure made had a basis weight of 781 grams per square meter.

### Example 2

### Spunlaced Filtration Structure of PPS Fibers with Laid Glass Scrim

A spunlaced filtration structure was made following the procedure described in Example 1 except that prior to hydro lacing a 68 gsm laid glass scrim was inserted. The filter structure made had a basis weight of 417 grams per square meter

### Comparative Example B

### Needle Felt Structure of PPS Fibers with PPS Scrim

A benchmark needle felt structure was made following a standard needle felting procedure containing a 142 gsm PPS woven scrim. The needle felt filter control structure made had a basis weight of 523 grams per square meter

Table 1 summarizes the filter felt characteristics for the samples described above.

TABLE 1
Fiber Felt Characteristics

| Felt | Comparative | | | Comparative |
|---|---|---|---|---|
| characteristic | Example A | Example 1 | Example 2 | example B |
| Basis Weight | 417 | 781 | 471 | 523 |
| (gsm) | | | | |
| Thickness | 1837 | 1877 | 1602 | 2186 |
| (microns) | | | | |
| Density | 0.23 | 0.42 | 0.29 | 0.24 |
| (g/cm3) | | | | |
| Air | 159 | 166 | 76 | 247 |
| Permeability | | | | |
| (L/cm2/min) | | | | |
| Pore | 18 | 19 | 15 | 26 |
| Diameter | | | | |
| (microns) | | | | |
| Pore volume | 83 | 70 | 79 | 83 |
| (%) | | | | |

Table 2 summarizes the performance characteristics for the examples of table 1.

TABLE 2
Test Results

| | Cycle or | Comparative | Ex- | | Comparative |
|---|---|---|---|---|---|
| Test | test time | Example A | ample 1 | Example 2 | Example B |
| Dust | Last 2 | 0.08 | 0.49 | 0.05 | 1.06 |
| Leakage | hours | | | | |
| Mg/m3 | cleaned at | | | | |
| | 1000 Pa | | | | |
| Filter | Last 2 | 346 | 247 | 340 | 265 |
| Pressure | hours | | | | |
| Drop | cleaned at | | | | |
| (Pa) | 1000 Pa | | | | |
| Cycle | Last 2 | 166 | 212 | 235 | 109 |
| Time (s) | hours | | | | |
| | cleaned at | | | | |
| | 1000 Pa | | | | |
| Dust | Last 2 | 170 | 110 | 96 | 179 |
| Retention | hours | | | | |
| (g/m2) | cleaned at | | | | |
| | 1000 Pa | | | | |

Table 2 demonstrates
a) the feasibility of producing spunlaced structures without-, and fragile (glass) and very strong (metal) scrims
b) that the filtration performance (VDI 3926 filter test) of a lighter spunlaced structure is superior to the benchmark needle felt made of PPS fibers.
   B) Blends of m-and p-aramid Fibers (NOMEX® KD from DuPont) Spunlaced Structures made with m-aramid Fiber (NOMEX® T450) Scrim, with Laid Glass Scrim and Compared to Scrimless Control Structures of NOMEX® T450

### Comparative Example C

### Spunlaced Filtration Structure of NOMEX® KD with NOMEX® T450 Woven Scrim

Spunlaced fabric of NOMEX® KD fibers was prepared by processing 250 kg of NOMEX® KD fibers from DuPont in a conventional opener, feeding system and then air-transported to the bottom and top cards. The card webs were compiled to the desired weights prior to entering the hydro lacing equipment. Prior to hydro lacing, a 65 gsm scrim made from NOMEX®T450 was inserted between the 2 carded webs. The hydro lacing equipment was equipped with 7 water jet heads, having a pressure range of up to 200 bar each. The hydro lacing process was conducted at a speed of around 6 m/minute and the fabric made had a basis weight of 405 grams per square meter.

### Example 3

### Spunlaced Filtration Structure of NOMEX® T450 with Laid Glass Scrim

A spunlaced filtration structure was made following the procedure described in Example 5 except that prior to hydro lacing, a 68 gsm laid glass scrim was inserted. The filter structure made had a basis weight of 420 grams per square meter

### Comparative Examples D and E

### Spunlaced Filtration Structure of NOMEX® T450 without Glass Scrim

A spunlaced filtration structure was made following the procedure described in Comparative Examiner C, except that prior to hydro lacing no scrim was inserted. The filter structures made have a basis weight of 399 and 418 grams per square meter

Tensile testing was carried out at 50 N on a 5 cm fabric strip extension force in machine direction (MD) based on ISO 9073-3 standard norm. Comparing the elongation at 50 Newtons over 5 cm width in MD the example 5 showed a very low elongation figure of 0.1%, whereas Comparative C showed an average of 0.9% with a deviation between 0.6 and 3.5% and the control scrimless structures D and E are in the order of 1.55% average with deviations between 1.2 and 2.9%. The lower elongation of the structure of the invention as compared to the comparative examples is shown by these data.

### C) Long Term Performance Testing.

A scrim supported spunlaced structure of NOMEX® T450 with a laid glass scrim was prepared. Basis weight of the laminate was 400 gsm. Thickness was 2.15 mm. These properties were essentially retained after aging.

Performance under filtration field test conditions confirmed that the laid scrim of glass did not get brittle nor did the glass fiber in the scrim break after 33 months under field test conditions at an average of 170° C. Retention of tensile strength of 33% was obtained after this aging.

Tensile testing was carried out for this sample at 25 Newtons on a 2.5 cm fabric strip extension force in machine direction (MD) based on ISO 9073-3 standard norm. Measurement of the loss in tensile strength over time surprisingly showed that the glass scrim at 50 N showed still less than 1% elongation.

What is claimed is:

1. A fabric structure comprising a fiber mat entangled to a support scrim and having a basis weight of at least 305 grams per square meter (gsm), wherein the fabric structure has an elongation of less than 3.0% extension in the machine direction under a load of 50 Newtons (N) over a width of 5 cm under standard test ISO 9073-3, and wherein the fabric structure has heat resistance after 2 years of aging at 150° C. defined as at least 30% retention of initial tensile strength, and wherein the support scrim has a basis weight of at least 35 grams per square meter and the scrim is located interior to the fiber mat.

2. The structure of claim 1 wherein the elongation of the structure is less than 1.0% extension in the machine direction under a load of 50 Newtons over 5 cm under standard test ISO 9073-3.

3. The fabric structure of claim 1 wherein the fiber mat comprises fibers made from a polymer from the group consisting of meta aramid, meta-amid-imide, para aramid, poly-imide, polyphenylene sulfide (PPS), polyether ether ketone (PEEK), polyether ketone ketone (PEKK), polytetrafluoroethylene (PTFE), and a combination of the foregoing.

4. The fabric structure of claim 1 wherein the support scrim less than 3.0% extension in the machine direction under a load of 50 Newtons over 5 cm under standard test ISO 9073-3.

5. The fabric structure of claim 4 wherein the support scrim less than 1.0% extension in the machine direction under a load of 50 Newtons over 5 cm under standard test ISO 9073-3.

6. The fabric structure of claim 1 in which the fabric laminate structure has heat resistance after 1 year defined as at least 30% retention of tensile strength at 190° C.

7. The fabric structure of claim 1 in which the fabric laminate structure has heat resistance after 1 year defined as at least 30% retention of tensile strength at 210° C.

8. The fabric structure of claim 1 in which the fabric laminate structure has heat resistance after 1 year of defined as at least 30% retention of tensile strength at 250° C.

9. The fabric structure of claim 1 wherein the support scrim comprises inorganic fibers.

10. The fabric structure of claim 9 where the support scrim comprises glass fibers.

11. The fabric structure of claim 10 wherein the support scrim has a basis weight of less than or equal to 100 grams per square meter.

12. The fabric structure of claim 9 where the support scrim comprises metallic fibers.

13. The fabric structure of claim 1 where the support scrim comprises para-aramid fibers.

14. The fabric structure of claim 1 wherein an e-PTFE membrane is adhesively laminated to the fabric laminate structure.

15. The fabric structure of claim 14 in which the e-PTFE membrane is adhesively laminated to the structure with an FEP resin.

16. A bag filter comprising the fabric structure of claim 1

17. A method of forming a fabric laminate structure comprising the steps of;
I. providing a mat of loose fibers in a form suitable for entangling,
II. inserting a support scrim into the mat of loose fibers, or adjacent to and in contact with the mat of loose fibers,
III. entangling the loose fibers and the support scrim to form a structure in which the loose fibers become intermingled with the support scrim
wherein the structure of step III has a basis weight of at least 305 grams per square meter (gsm), and an elongation of less than 3.0% extension in the machine direction under a load of 50 Newtons (N) over a width of 5 cm under standard test ISO 9073-3, wherein the structure has heat resistance after 2 years of aging at 150° C. defined as at least 30% retention of initial tensile strength, and wherein the support scrim has a basis weight of at least 35 grams per square meter.
